(19) United States
(12) Patent Application Publication
(10) Pub. No.: US 2017/0116790 A1
(43) Pub. Date: Apr. 27, 2017

(54) METHOD AND SYSTEM FOR AN AUTOMATED PARKING SYSTEM

(71) Applicant: COLLATERAL OPPORTUNITIES, LLC, Wilmington, DE (US)

(72) Inventors: BRUCE HOWARD KUSENS, NORTH MIAMI BEACH, FL (US); MICHAEL KUSENS, COOPER CITY, FL (US)

(21) Appl. No.: 15/298,918

(22) Filed: Oct. 20, 2016

Related U.S. Application Data
(60) Provisional application No. 62/245,016, filed on Oct. 22, 2015.
(60) Provisional application No. 62/269,221, filed on Dec. 18, 2015.

(51) Int. Cl. G07B 15/02; G06K 9/00; G06Q 30/02; G08G 1/14

(52) U.S. Cl. CPC G07B 15/02; G08G 1/142; G06K 9/00812; G06K 9/00825; G08G 1/144; G06Q 30/0284; H04L 67/12

(57) ABSTRACT

A system and method for automating parking at a facility such as, but not limited to, a parking garage. Using vehicle sensors located at the monitored parking spaces, information received from the vehicle sensors can be used by an electronic parking system to determine which spaces are open or otherwise available. Registered users can be notified of the available spaces and then can select which spot they want where multiple spaces are presented to them. The user's payment information can also be setup, such that the payment for parking at the selected space is automatically deducted by the parking system.

This application claims the benefit of and priority to U.S. Provisional Patent Application Ser. No. 62/245,016, filed Oct. 22, 2015, and claims the benefit of and priority to U.S. Provisional Application Ser. No. 62/269,221, filed Dec. 18, 2015. All of the above applications are incorporated by reference in their entireties for all purposes.

### BACKGROUND

Parking lots are a ubiquitous feature of American cities. Though no exact figures exist, it is estimated that there are between 105 million and 2 billion parking spaces in the United States. One third of these spots are in parking lots, where in some cities, parking lots cover over one third of the land area. Conservative estimates suggest that $25-30 billion dollars are spent each year in parking fees.

Though it is a multibillion-dollar industry, the parking industry has generally been slow to adapt to technological changes, and for the consumer, the experience of parking has remained relatively unchanged since the advent of the automobile. An incalculable amount of time is spent each year by motorists searching for parking spots, paying for parking, and waiting in the queue to enter and egress from a parking facility. The disclosed embodiments are directed to the above problems.

### SUMMARY OF THE DISCLOSURE

Embodiments for a system and method are disclosed that allow a parking facility to reserve and monitor parking spaces, collect payment, contact drivers, and/or guide users to available parking spaces. The following non-limiting definitions are provided as an aid in understanding at least certain embodiments for the disclosed novel method and system:

| | |
|---|---|
| Parking System | Any electronic device or set of electronic devices configured and/or |
| | specifically programmed to compute, process, store, display, handle, |
| | and/or use any form of digital information and/or digital data suitable |
| | for the embodiments described herein. As non-limiting examples, the |
| | parking system could include a single computer server located at the |
| | parking facility or elsewhere, or multiple computing devices which |
| | may be implemented in or with a distributed computing and/or |
| | clouding computing environment with a plurality of servers and |
| | cloud-implemented resources. Thus, a parking system may include |
| | one or more servers. The parking system may include one or more |
| | processing resources communicatively coupled to one or more storage |
| | media, one or more electronic databases, random access memory |
| | (RAM), read-only memory (ROM), flash memory, and/or other types |
| | of memory. The parking system may include any one or combination |
| | of various input and output devices (I/O) devices, network ports, and |
| | display devices. The parking system may include wireless |
| | connectivity to the Internet, a wide area network (WAN), a local area |
| | network (LAN), a wireless local area network (WLAN), intranet, a |
| | metropolitan area network (MAN), a cellular network, such as 4G, |
| | 3G, GSM, etc., another wireless network, a gateway, and/or any other |
| | appropriate architecture or system that facilitates the communication |
| | of signals, data, and/or messages in order to send and receive data |
| | and/or voice or text messaging communications. |
| Beacon | A beacon comprises the components designed to send and receive |
| | electronic data used for monitoring a designated parking space. A |
| | beacon may include any number of vehicle sensor(s) and/or wireless |
| | transmitter(s)/receiver(s). The beacon may be connected to the parking |
| | system network through a wired or wireless network or another long |
| | or short-range frequency transmitter, or any other preferably wireless |
| | transmission and/or communication technology now known or later |
| | developed. |
| Communication Device | Any electronic device which can utilize one or more of the following: |
| or Device | the Internet, a wide area network (WAN), a local area network (LAN), |
| | a wireless local area network (WLAN), intranet, a metropolitan area |
| | network (MAN), a cellular network, such as 4G, 3G, GSM, etc., |
| | another wireless network, a gateway, and/or any other appropriate |
| | architecture or system that facilitates the communication of signals, |
| | data, and/or messages in order to send and receive data and/or voice |
| | communications. As a non-limiting example, cellular and/or smart |
| | telephones and/or electronic tablets are considered to fall under this |
| | definition. |
| Indicator | Any number of the following: one or more signs, lights, auditory or |
| | visual alarms, sirens, sounds, or other means of communication or |
| | notification, which can be preferably operated through one or more |
| | wireless transmitter(s)/receiver(s). The indicator may be connected to |
| | the parking system through a wired or wireless network or another |
| | long or short-range frequency transmitter, or any other preferably |
| | wireless transmission and/or communication technology now known |
| | or later developed. An indicator may be physically integrated into the |
| | parking facility or a particular park spot(s) location, located or |
| | positioned above, below, adjacent to, or in any configuration and/or |
| | orientation where the indicator's components can convey the |
| | availability or lack of availability of a monitored parking spot to an |
| | observer, while preferably maintaining connection to the parking |
| | system. |
| Monitored Parking | A parking space which is administered by a parking system in |
| Space or Parking Space | accordance with one or more of the disclosed embodiment(s). |
| Parking Area or | Any building, structure, facility, garage, parcel of land, parking lot, |
| Parking Facility | parking apace, right-of-way, surface, geographical area, street used for |
| | the parking of motor vehicles. |
| Parking Database | A computer database that electronically indexes information relating |
| | to monitored parking spaces, registered vehicles and can be in wired |
| | or wireless communication with the Parking System. Information |
| | relating to monitored parking spaces includes as non-limiting |
| | examples, the location of monitored parking spaces, a record of which |
| | parking spaces are occupied and/or available, the availability of |
| | parking spaces, the parking rates for parking spaces, any restrictions |
| | or reservations for the parking space(s), and/or time limits for parking |
| | spaces. Information relating to registered vehicles includes as non- |
| | limiting examples, which vehicles are registered in the Parking |
| | System, identification information for registered vehicles (for non- |
| | limiting example, the make, model, and/or license plate number), a |
| | designated or reserved parking spot assigned to a registered vehicle |
| | and/or at least one financial account for each registered vehicle, such |
| | as, but not limited to, debit card information, credit card information, |
| | bank account information, etc., which the registered user can |
| | authorized access by the Parking System in order to deduct parking |
| | charges. |
| Payment Account | An account assigned to a user which may provide a prepaid balance |
| | with which to pay a parking fee(s) or charge(s). Funds may be added |
| | to a payment account for non-limiting example, by debit or credit card |
| | payment, wire/bank transfer, or any other generally accepted means of |
| | affecting payment now used or later developed. Alternatively, the |
| | Parking System can be authorized to directly withdraw parking |
| | charges from the registered user's debit or credit card, bank account, |
| | etc. |
| Registered Vehicle | Any vehicle registered in one or more embodiments of the parking |
| | system. The user of a Registered Vehicle may provide to the Parking |
| | Database (through electronic or analog means) information, for non- |
| | limiting example, make, model, color and/or license plate number for |
| | the vehicle. |
| Regular User | Any User who has parking preferences stored in the parking system in |
| | order to expedite providing a parking space (for non-limiting example, |
| | an assigned parking space) to that user. |
| Transmission | The broadcasting of electromagnetic waves, signals, radio waves, |
| | electrical signals, light signals, Bluetooth signals, beacon signal, |
| | and/or other long or short-range frequency transmission and/or |
| | communication techniques now known or later developed. |
| User | Any person or vehicle which makes use of the parking system for |
| | parking. |
| Vehicle Sensor | Sensors installed which can determine the presence and/or absence of |
| | a vehicle in a monitored parking space. The sensor(s) can be |
| | integrated into the parking area. As non-limiting examples, this may |
| | include magnetic sensors integrated into the surface of the parking |
| | area, visual sensors integrated into the roof or wall of a parking area, |
| | magnetic field sensors (Hall Effect or Reed type sensors) that can |
| | detect the presence or change in magnetic fields caused by metallic |
| | objects such as vehicles and/or any other configuration which allows |
| | for the sensor(s) to determine the presence or absence of a vehicle in |
| | the monitored parking space associated with the sensor(s). A |
| | combination of two or more of the above and below identified types of |
| | sensors can also be used together. Additional non-limiting examples |
| | include, but are not limited to, pressure or weight sensors which can |
| | detect when a vehicle is in a parking space, RF signals, Infrared Light, |
| | Ultrasonic sound Lasers. There may be one or more sensors for each |
| | parking space, or in the alternative, one sensor may monitor multiple |
| | parking spaces. |

### BRIEF DESCRIPTION OF THE DRAWINGS

FIG. 1 is a process flow diagram for one non-limiting embodiment for an automated parking management method and system in accordance with the present disclosure;

FIG. 2 is a process flow diagram for one non-limiting embodiment for determine available parking space in accordance with the present disclosure;

FIG. 3 is a process flow diagram for one non-limiting embodiment for monitoring parking spaces within a parking facility in accordance with the present disclosure;

FIG. 4 is a process flow diagram for one non-limiting embodiment for determining whether a correct signal was received in accordance with the present disclosure;

FIG. 5 is a process flow diagram for one non-limiting embodiment for payment for the method and system in accordance with the present disclosure;

FIG. 6 is a block diagram of certain components for the system in one non-limiting embodiment in accordance with the present disclosure;

FIG. 7 is a block diagram illustrating the use of indicators, beacons and vehicle sensors for one embodiment of the disclosed system;

FIG. 8 is a block diagram illustrating the use of indicators, beacons and vehicle sensors for another embodiment of the disclosed system; and

FIG. 9 is a process flow/block diagram for determining a parking space availability for one embodiment of the disclosed system.

### DESCRIPTION OF DRAWINGS

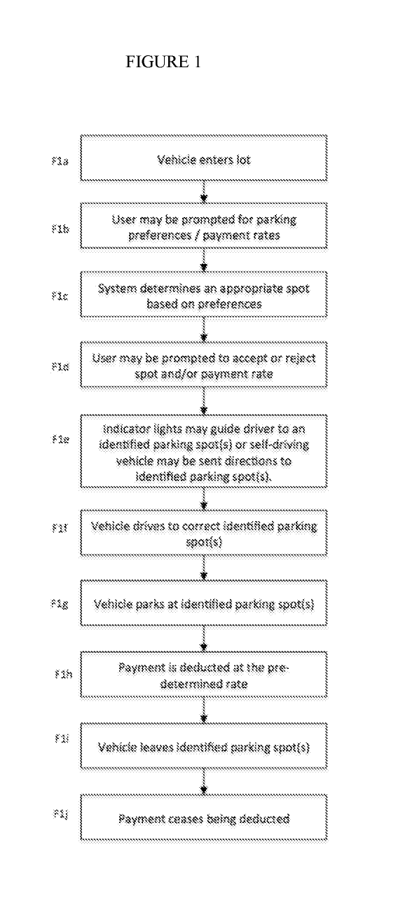

As seen in FIG. 1 a non-limiting process flow/method for an automated parking management and payment collection system is shown and described below in relation to a mobile device. However, other electronic devices can also be used for performed the described steps, such as, but not limited to, a vehicle's wireless communication system and are also considered within the scope of the disclosure.

At block F1a, a vehicle enters a monitored parking facility. This can occur when a traditional vehicle is driven into the facility by a user, or additionally or in the alternative, in a self-driving vehicle. If a user wishes to utilize the novel parking system disclosed herein in several non-limiting embodiments, the user preferably installs or downloads on their device a software program/App or other means of interfacing with the parking system. At or near the entrance to the parking facility there may be located one or more beacons designed to detect when a vehicle has entered the facility. The beacon may then subsequently establish communication with the device with the software program installed/running in order to precipitate use of the parking system.

At block F1b, the user may be prompted to enter through their device their destination, parking space preferences, maximum acceptable parking rate, estimated duration time that they expect to have or need their vehicle to be parked at the location, or other inputs necessary to allow the system to determine an appropriate parking spot and direct the user to the identified parking space. In addition to or in the alternative, if the user is determined to be a regular user, such as, but not limited to, a user with an assigned parking spot, then the process may advance directly to block F1e.

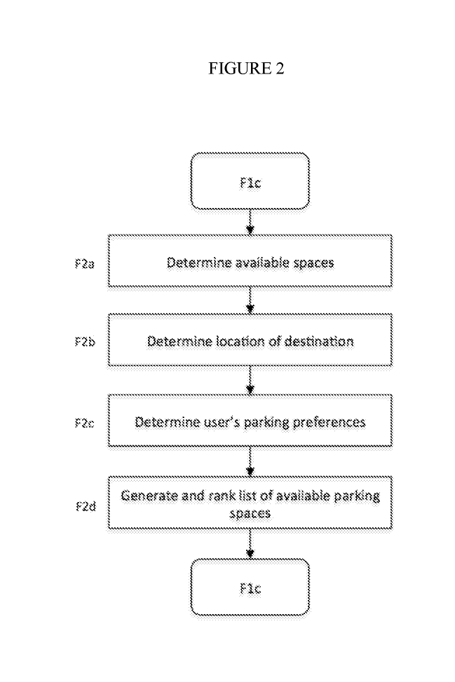

At block F1c, based on the user's parking preferences, the system determines a parking spot or spots for the user. Alternative spots are determined in the event the user rejects the spot as described in block F3d. This process is described in further detail in the description for FIG. 2.

At block F1d, the user may be presented with the identified spot or spot(s) and the associated parking rate for those spots. The user may be given the chance to accept or reject the identified spot(s). If the user rejects the spot(s), then the system presents alternative spot(s). In the event there are no alternative spots, a message indicating that fact can be presented to the user. If the user accepts the spot, the spot is marked as reserved in the system and not presented as an option to other subsequent users, until the parking system determines that the vehicle has left. Alternatively or additionally to a user being presented with identified parking spot(s), some embodiments may allow a user with a device with a software program or other means of interfacing with the parking system to park in any unoccupied parking spot within the parking facility, and in such case the process may advance directly to block F1h.

At block F1e, indicator lights may guide a user to the identified parking spot(s), and if the user is a self-driving car, the vehicle or the vehicle's computer may be sent directions/electronic directions to the identified parking spot(s).

At block F1f, the vehicle is driven to the identified parking spot(s).

At block F1g, the vehicle parks at the identified parking spot(s).

At block F1h, the user's payment account can be deducted per the terms of the parking rate set in block F1d. As a non-limiting example, a flat fee could be deducted when the vehicle parks, or in the event of an hourly rate, payment could be deducted as time elapses while the vehicle is parked in the identified spot. The parking system can also be programmed or configured to charge a percentage of the hourly rate, where the vehicle is parked for a time period that isn't a multiple of 60 minutes (i.e. vehicle is parked for 30 minutes, the user is billed 50% of the hourly rate). In some embodiments the parking system through its connection to the network may transmit a text message to the user or place an automated phone call to a user providing that user with information. As a non-limiting example, the information can include payments made or deducted from the user's account, time limits being approached and/or reached, warnings to move the vehicle if the user's vehicle is parked during a restricted time zone, such as which may occur if the user is occupying a reserved or otherwise (permanently or temporarily) restricted space, and other parking information.

At block F1i, the vehicle is driven out of the identified parking spot(s).

At block F1j, when the vehicle is no longer detected in the identified parking spot, then payment ceases being deducted and/or charges stop incurring.

FIG. 2 shows a non-limiting example of a subprocess or subroutine that can be used for the available parking determination made in block F1c in FIG. 1, in accordance with certain embodiments in the present disclosure. Preferably, the determination steps are performed by the parking system.

At step F2a, using data/information from the parking database, the system determines which parking spaces within the parking facility are available. The parking database maintains a dynamic list of which parking spaces are occupied, reserved, or otherwise unavailable at a given time. Availability of a parking space may be contingent on factors such as current or future occupancy, reservations, time limitations, obstructions, maintenance or any other factor which may limit the ability of a vehicle to park in a particular parking spot.

At step F2b, the parking system may then determine the destination of the user. This may occur by the user directly transmitting that information to the parking system through an input on the user's device, or by the system determining the likely destination of the user. This determination may be based on configurable factors such as which destinations have been selected by users of the parking facility on a given day, the most common destination of users on certain days and/or times, the user's previously entered destination, or any other means of ranking the likely destination of a user.

At step F2c, the parking system may then determine the parking preferences of the user. This may occur by the user directly transmitting that information to the parking system through an input on the user's device, or by the system determining the likely preferences of a user. These preferences may include as a non-limiting exactly, the distance between a parking spot and the user's destination, the fee associated with a given parking space, factors such as whether a parking spot is adjacent to occupied or unoccupied parking spaces, the style of parking space (as a non-limiting example, parallel parking spaces, straight in parking spaces, angled parking spaces, etc.), the distance of the parking space to the exit and/or elevator/escalator, any temporary or permanent disability of the driver or any other occupant in the vehicle, the size of the vehicle, or any other preference or requirement of a user.

At step F2d, the parking system may then rank the available spaces. Spaces may be ranked based, as a non-limiting example, by assigning a value or weight to the preferences considered in step F2c. This valuation or weighing of preferences may be determined by a user directly transmitting that information to the parking system through an input on the user's device, and/or by a configuration in the parking system.

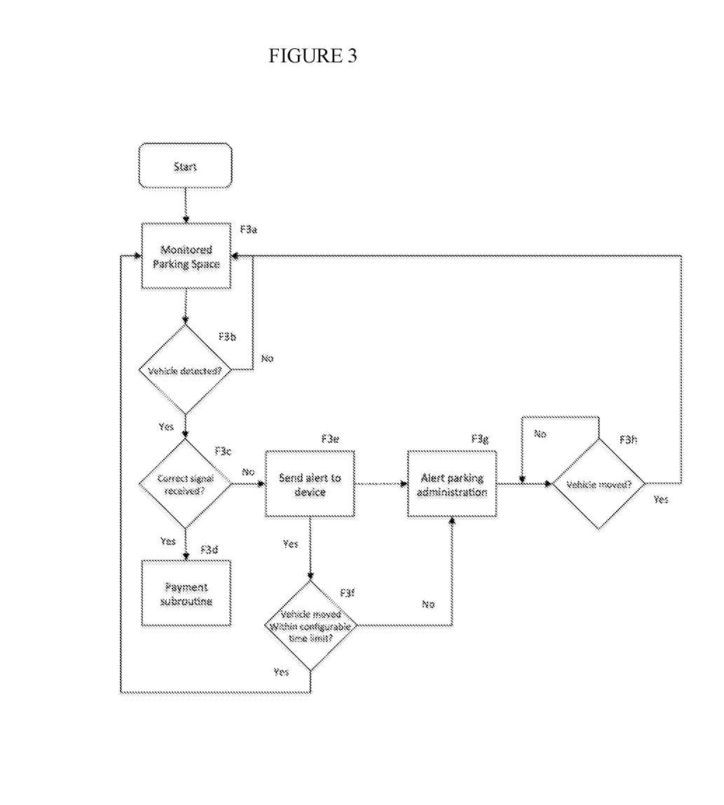

FIG. 3 shows the workflow for monitoring parking spaces within a parking facility through the use of one or more beacons, and/or other sensors, with the monitoring preferably centralized performed by the parking system.

At block F3a, an unoccupied monitored parking space can be any parking space within the database associated with the parking system in which no vehicle is currently parked.

At decision block F3b, if no vehicle is detected in the monitored parking space by the parking system based on information received from a beacon or other sensor (collectively “beacon”) associated with the parking space (with the beacon/sensor sending/transmitting data to the parking system for monitoring that parking space), then the beacon continues to send data to the parking system for monitoring that parking space.

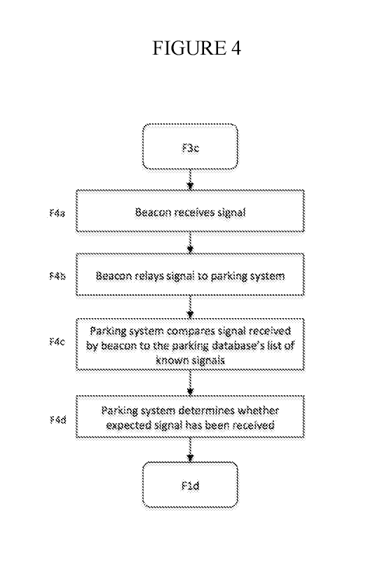

At decision block F3c, if a vehicle is detected by the parking system based on information received from the beacon or sensor, the system determines whether the vehicle is authorized to park in that monitored parking spot by monitoring for the presence of a unique signal transmitted by the user's device who is associated or assigned with the vehicle parked in the parking spot. This transmission(s) may be made to a receiver associated with the beacon(s) by the user's device electronically connected to a wireless transmitter(s)/receiver(s) (and/or by the vehicle's electronic system), which enables the user to transmit and/or receive data through Bluetooth or another long or short-range frequency transmission technology or by other preferably wireless transmission technology now known or later developed. One non-limiting embodiment for this process is described in further detail in the description of FIG. 4.

At block F3d, if the correct signal from the user's device (or vehicle's computer system) is determined/received by the parking system from information transmitted by the user' device (vehicle's computer system) to the beacon and forwarded or otherwise sent from the beacon to the parking system, the payment subroutine can begin. In some embodiments, the parking system may be configured or programmed to send text messages or place automated phone calls to inform users of various events, such as, but not limited to, confirmation of arrival, confirmation of departure, information about an event that they are parking their car for, warnings to move their vehicle if the vehicle is parked in a restricted time zone or if they are occupying a reserved space, information about payment or balances, or other parking information.

At block F3e, if an incorrect signal is determined by the parking system from information transmitted by the user's device (or vehicle electronic system) to the beacon and forwarded or otherwise sent from the beacon to the parking system, an alert is sent to the device (and/or vehicle system) by the parking system indicating to the user that they have parked in an unauthorized space. Additionally or in the alternative, instructions and/or directions could be sent to the user's device or self-driving car to exit the area or park in an authorized location (and the parking system can also provide information to the user's device with one or more authorization locations that are currently available for the user to park his or her vehicle at). If no signal is determined by the parking system from information or the absence of information transmitted by the user's device (vehicle system) to the beacon and forwarded or otherwise sent to the parking system, the process may advance to block F3g.

At block F3g and decision blocks F3f and F3h, the parking system monitors the parking space through information received from the beacon to determine whether the vehicle has been moved within a configurable time limit. If beacon detects that the vehicle is no longer in the parking space, then normal monitoring resumes and the database can be updated to indicate that the parking space is now currently available for future space determinations performed by the parking system (unless there is some other restriction on the space or the space is already reserved by a user). If a vehicle is not moved within the configurable length of time or if no signal is received in block F3e, then the parking administration can be alerted, the user can be alerted and/or additional charges or fines can be deducted from the user's account by the parking system.

To further confirm the violation, one or more cameras can be set up in the parking facility which are in electronic communication with the parking system. Where the parking system determines a parking violation by the user, the parking system can send a signal to one or more of the cameras to take a digital image, that is preferably time and date stamped, of the vehicle in the parking spot. The digital image can be stored in the hard drive, disk, database, etc. of the camera or can be transmitted to the parking system and stored in the database in communication with the parking system. The digital image can be used as evidence, in the event the user disputes that their vehicle was parked in the parking spot unauthorized.

If the parking system detects, from information received from the beacon, that the vehicle is no longer in the parking space, then normal monitoring resumes, similar to as described above.

FIG. 4 shows a non-limiting example of a subprocess or subroutine corresponding to F3c of the method disclosed in FIG. 3 for determining whether a correct signal was transmitted/received, in accordance with certain embodiments in the present disclosure. Preferably, the determination is performed by the parking system.

At step F4a, devices within the parking system transmit a unique signal which may be made to a receiver associated with the beacon(s) by the user's device electronically connected to a wireless transmitter(s)/receiver(s), which enables the user to transmit and/or receive data through Bluetooth or another long or short-range frequency transmission technology or by other preferably wireless transmission technology now known or later developed.

At step F4b, when the receiver associated with the beacon(s) detects any signal transmitted by a device, that signal is then forwarded or otherwise sent from the beacon to the parking system.

At step F4c, the parking system compares the signal which has been forwarded by the beacon(s) to a known database of signals which are stored in the parking database and assigned or associated with a given user's account. Through this comparison, the parking system automatically determines which user's device has transmitted the signal which has been received by the beacon(s).

At step F4d, once the system determines which user's device transmitted the signal which has been received by the beacon(s), the parking system then determines whether that user is authorized to park in the monitored parking space.

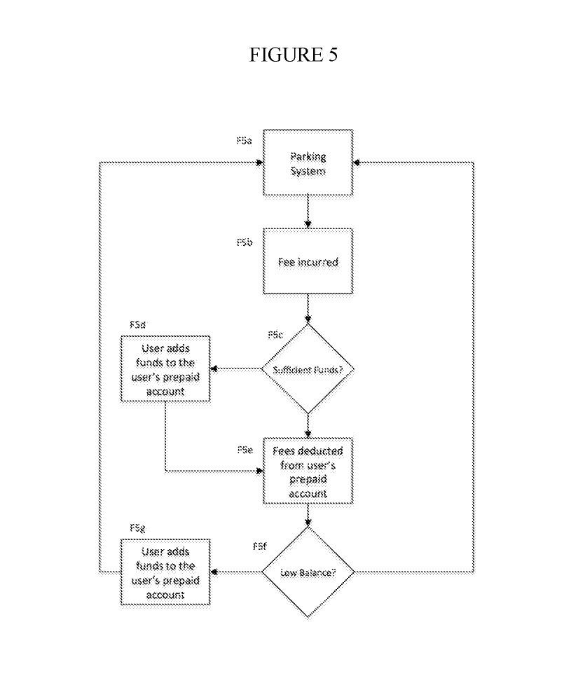

FIG. 5 shows a non-limiting example of a subprocess or subroutine for allowing the prepayment of parking fees, in accordance with certain embodiments in the present disclosure. The prepayment method can be preferably performed by the parking system.

At block F5a, the parking system may determine when users incur a fee(s) or charge(s). This may occur, as a non-limiting example, when a user accepts the payment rate of a parking space as described in block F1d, or when a user incurs a fee for a parking violation, and/or when a user is charged for a pre-paid or reserved parking space, such as, but not limited to, a recurring monthly parking fee.

At block F5b, the parking system may determine that a user has incurred a fee(s) or charge(s).

At decision block F5c, the parking system determines whether a user has sufficient funds in their pre-paid account to pay for the charges which have been incurred by the user.

At block F5d, if a user has insufficient funds in their payment account to pay for the fee(s) or charge(s) incurred, the user may be prompted to add funds to the payment account. The user may transfer funds to the parking system administrator by non-limiting example, through debit or credit card, wire/bank transfer, or any other generally accepted means of affecting payment now used or later developed. Additionally or in the alternative, the user may provide the parking system with payment information to be stored in the parking database to allow for the parking facility to automatically obtain payment from the user. When payments are made by the user, the user may be given an equivalent credit in their payment account by the parking system. A second method of payment (i.e. credit card) can also be stored in a database associated with the parking system and used/charged where funds in the user's account or zero or low or insufficient to cover all of the current parking charges/fees. Additionally, the parking system can be programmed to automatically replenish a user's account, such as, but not limited to, charging a user's credit card, upon the user's account fallen below a predefined/preconfigured minimum amount/threshold of money/funds.

At block F5e, if a user has sufficient funds in their payment account to pay for the fee(s) or charge(s) incurred, the user's payment account can be debited by an amount equal to that fee(s) or charge(s) as described in block F1h (unless the user has indicated to or informed the parking system to make the payment owed from another source, such as, but not limited to, a credit or debit card). Alternatively, as mentioned in block F5d, if funds are not sufficient, a credit card for the user can also be on electronic file with the parking system, and the parking system can charge the credit card for the current charges not covered by any funds in the user's account.

At block F5f, if after the user's payment account is deducted for payment of fee(s) or charge(s) the account balance falls below a predetermined/preconfigured threshold, the user may add funds to their payment account and/or their credit card be charged in block F5g, similar to as described in block F5d. Otherwise, the parking system continues to determine whether new fee(s) or charge(s) have been incurred by the user.

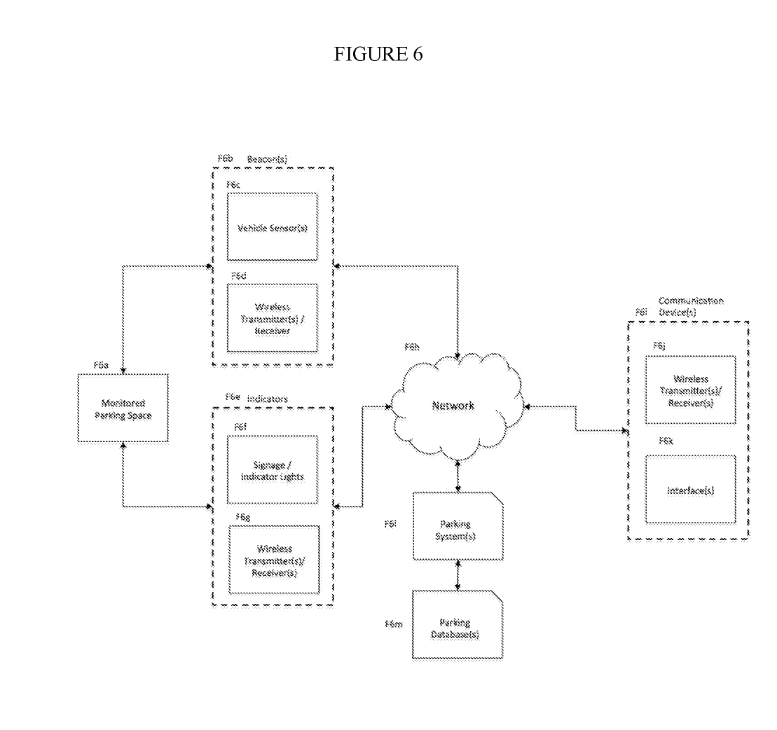

FIG. 6 illustrates components that can be used in practicing at least one embodiment for the above described method and system how the components communicate with each other.

Block F6a represents a parking space within any parking area that is monitored by the location based parking system.

Block F6b show beacon(s) which preferably consists of the components designed to monitor the parking space F6a. The beacon may include any number of vehicle sensor(s) and wireless transmitter(s)/receiver(s). The beacon(s) may be connected to the network through a wired and/or wireless network or another long or short-range frequency transmitter, or any other preferably wireless transmission technology now known or later developed. The beacon(s) may be physically integrated into the parking facility, located above, below, adjacent to, and/or in any configuration where the beacon's components can monitor the parking spot F6a and maintain connection to the network.

Block F6c represent vehicle sensor(s) which can be a sensor or series/plurality of sensors designed to detect when a vehicle is located within a monitored parking spot. Non-limiting examples include motion sensors, pressure sensors, weight sensors and/or magnetic field sensors, which can be used in the detection of when a vehicle is located within a monitored parking space. When the parking system detects, based on data received from on or more vehicle sensor(s) of the beacon(s), that a vehicle is located within a monitored parking space, a signal will be sent to the Network that the monitored parking space is occupied and that data may be stored in one or more parking database(s). This signal can be transmitted through a wire or the wireless transmitter/receiver (F6d) though a long or short-range frequency transmission technology or by other preferably wireless transmission technology now known or later developed.

As seen in block F6d, the beacon(s) may include one or more wireless transmitter(s)/receiver(s), which enable the beacon to transmit and/or receive data through wires or Bluetooth or another long or short-range frequency transmission technology or by other preferably wireless transmission technology now known or later developed. In addition or in the alternative, audio/video telemetry may be transmitted to a remote storage/monitoring location so long as a data connection (TCP/IP or comparable technology) exists between the beacon and the remote storage/monitoring location.

Block F6e represents indicator(s) which can consist of the components designed to convey to an observer whether a monitored parking spot is available. The indicator may include any number of one or more signs, lights, auditory or visual alarms, sirens, or other means of communication and one or more wireless transmitter(s)/receiver(s). The indicator may be connected to the network through a wired or wireless network or another long or short-range frequency transmitter, or any other preferably wireless transmission technology now known or later developed. An indicator may be physically integrated into the parking facility, located above, below, adjacent to, or in any configuration where the indicator's components can convey the availability or lack of availability of a monitored parking spot(s) to an observer and maintain connection to the network.

Block F6f represents signage/Indicator(s) which can consist of the components designed to convey to an observer whether a monitored parking spot is available. The indicator may include any number of one or more signs, lights, auditory or visual alarms, sirens, or other means of conveying the availability of a monitored parking space and one or more wireless transmitter(s)/receiver(s). The indicator may also be used to alert parking lot administration, as a non-limiting example, that a vehicle is not in compliance with the parking lot rules, such as when an unauthorized vehicle parks in a monitored parking space.

Block F6g represents wireless Transmitter(s)/Receiver(s) which may include one or more wireless transmitter(s)/receiver(s), which enable the beacon to transmit and/or receive data through wires or Bluetooth or another long or short-range frequency transmission technology or by other preferably wireless transmission technology now known or later developed. In addition or in the alternative, audio/video telemetry may be transmitted to a remote storage/monitoring location so long as a data connection (TCP/IP or comparable technology) exists between the beacon and the remote storage/monitoring location.

Network F6h may be any suitable means to facilitate data transfer in the system. Non-limiting examples include utilizing one or more of the following: the Internet, a wide area network (WAN), a local area network (LAN), a wireless local area network (WLAN), intranet, a metropolitan area network (MAN), a cellular network, such as 4G, 3G, GSM, etc., another wireless network, a gateway, and/or any other appropriate architecture or system that facilitates the communication of signals, data, and or messages. Network F6h may transmit data using any suitable wireless and/or wired communication protocol. Network F6h and its various components may be implemented using hardware, software, and communications media such as wires, optical fibers, microwaves, radio waves, and other electromagnetic and/or optical carriers, as well as any combination of the foregoing.

Block F6i represents Communication Device(s) which can include, without limitation, cellular telephones which can utilize one or more of the following: the Internet, a wide area network (WAN), a local area network (LAN), a wireless local area network (WLAN), intranet, a metropolitan area network (MAN), a cellular network, such as 4G, 3G, GSM, etc., another wireless network, a gateway, and/or any other appropriate architecture or system that facilitates the communication of signals, data, and or messages in order to send and receive data and/or voice communications.

Block F6j represents Wireless Transmitter(s)/Receiver(s) that may include one or more wireless transmitter(s)/receiver(s), which enable the beacon to transmit and/or receive data through wires or Bluetooth or another long or short-range frequency transmission technology or by other preferably wireless transmission technology now known or later developed. In addition or in the alternative, audio/video telemetry may be transmitted to a remote storage/monitoring location so long as a data connection (TCP/IP or comparable technology) exists between the beacon and the remote storage/monitoring location.

Block F6k represents interface(s) which can include any suitable electronic input/output module or other electronic system/device operable to serve as an interface between a device and the network. The Interface(s) may facilitate communication over the Network using any suitable transmission protocol and/or standard.

Block F6m represents the parking database(s) that may include a remote or onsite database in which parking information may be stored and written to. Non-limiting examples of information stored in the parking database may include a list of available parking spaces and their locations, directions for users to reach parking spaces, parking rules and rates, parking preferences for users and administrators, and other parking information.

Block F6l represents the parking system that may include a remote or onsite electronic device or set of electronic devices configured to compute, process, store, display, handle, and/or use any form of digital information and/or digital data suitable for the embodiments described herein. The parking system may include wireless connectivity to the Internet, a wide area network (WAN), a local area network (LAN), a wireless local area network (WLAN), intranet, a metropolitan area network (MAN), a cellular network, such as 4G, 3G, GSM, etc., another wireless network, a gateway, and/or any other appropriate architecture or system that facilitates the communication of signals, data, and/or messages in order to send and receive data and/or voice or text messaging communications. The parking system may be configured to transmit text messages or place automated phone calls to users when certain pre-determined or pre-configured criteria are met. As non-limiting examples, the parking system may send text messages to users to confirm the user has departed from a parking facility, warnings to move their vehicle if the vehicle is parked in a restricted time zone or if the vehicle is occupying a reserved space, information about payment or balances, or other parking information.

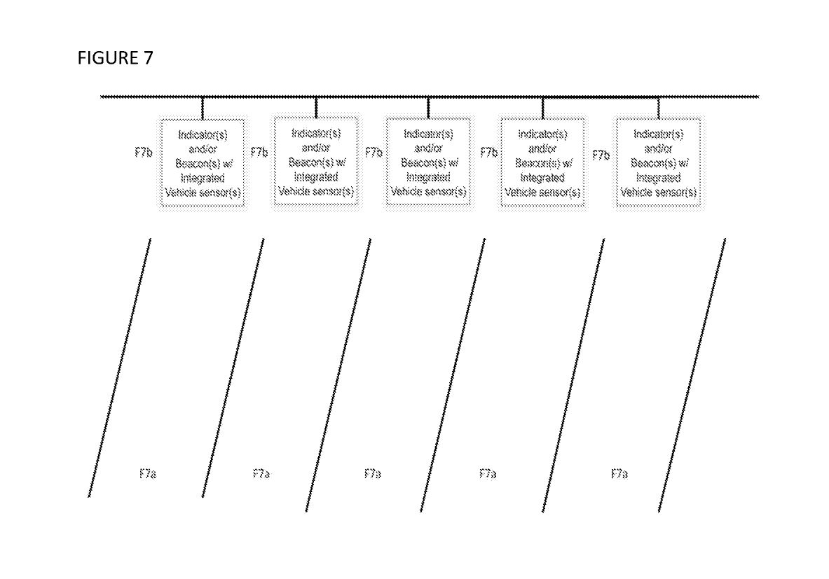

FIG. 7 illustrates a non-limiting of how indicator(s), beacon(s) and vehicle sensor(s) can be employed in connection with at least one embodiment of the disclosed system and method. A monitored parking space F1a can be any parking space within the located based parking system. Blocks F7b show beacon(s) which can be comprised of the components designed to send and receive data to the parking system in order to monitor designated parking space(s). The beacon may include any number of vehicle sensor(s) and wireless transmitter(s)/receiver(s), though the components can be integrated into a single physical unit or separate components used in conjunction with each other. Vehicle sensor(s) can include, but is not limited to, magnetic sensors integrated into the surface of the parking area, visual sensors integrated into the roof or wall of a parking area, pressure or weight sensors which can detect when a vehicle is in a parking space, RF signals, infrared light, ultrasonic sound, lasers, magnetic field sensors (Hall Effect or Reed type sensors) that can detect the presence or change in magnetic fields caused by metallic objects such as vehicles and/or any other configuration which allows for the sensor(s) to determine the presence or absence of a vehicle in the monitored parking space associated with the sensor(s). A combination of two or more of the above and below identified types of sensors can also be used together. The beacon may be connected to the network through a wired or wireless network or another long or short range frequency transmitter, or any other preferably wireless transmission technology now known or later developed. A beacon may be physically integrated into the parking facility, located above, below, adjacent to, or in any configuration where the beacon's components can monitor a monitored parking spot and maintain connection to the network.

As non-limiting examples, there may be one beacon monitoring one parking space, or one beacon may monitor multiple parking spaces. Additionally, indicator lights may correspond to one specific parking spaces, or multiple parking spaces.

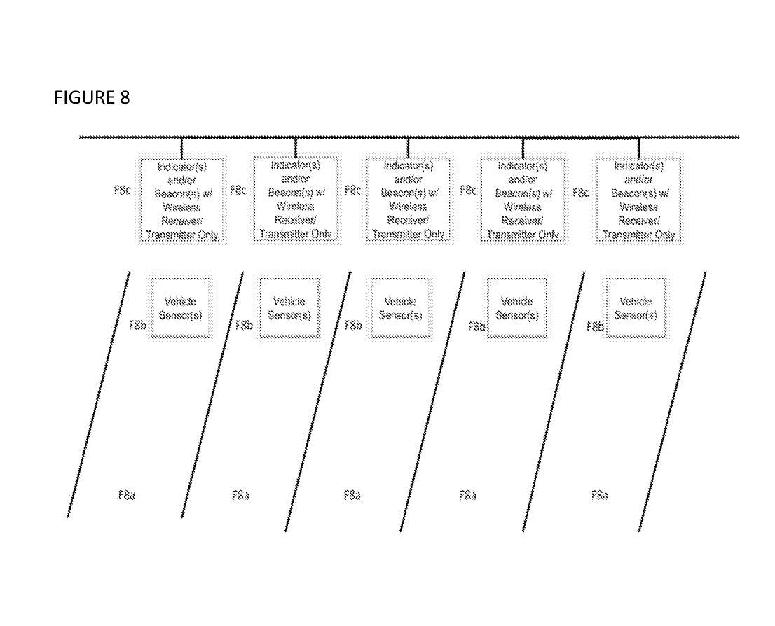

FIG. 8 illustrates another embodiment for employing the indicator(s), beacon(s) and vehicle sensor(s) within the system and method. A monitored parking space F8a can be any parking space within the located based parking system. Blocks F8b represent vehicle sensor(s) which can be placed within the parking space(s). The vehicle sensor(s) can include, without limitation, magnetic sensors integrated into the surface of the parking area, visual sensors integrated into the roof or wall of a parking area, pressure or weight sensors which can detect when a vehicle is in a parking space, RF signals, infrared light, ultrasonic sound, lasers, magnetic field sensors (Hall Effect or Reed type sensors) that can detect the presence or change in magnetic fields caused by metallic objects such as vehicles and/or any other configuration which allows for the sensor(s) to determine the presence or absence of a vehicle in the monitored parking space associated with the sensor(s). A combination of two or more of the above and below identified types of sensors can also be used together. The vehicle sensor(s) are in communication with the beacon(s) and/or parking system. The beacon(s) of block F8c can be comprised of components designed to send and receive data to the parking system in order to monitor designated parking space(s). The beacon may include any number of wireless transmitter(s)/receiver(s) and can be in communication with the (or include in some embodiment) any number of vehicle sensor(s), as the components can be integrated into a single physical unit or separate components used in conjunction with each other. The beacon may be connected to the network through a wired or wireless network or another long or short range frequency transmitter, or any other preferably wireless transmission technology now known or later developed. A beacon may be physically integrated into the parking facility, located above, below, adjacent to, or in any configuration where the beacon's components can monitor a monitored parking spot and maintain connection to the network.

As non-limiting examples, there may be one beacon monitoring one parking space, or one beacon may monitor multiple parking spaces. Additionally, indicator lights may correspond to one specific parking spaces, or multiple parking spaces.

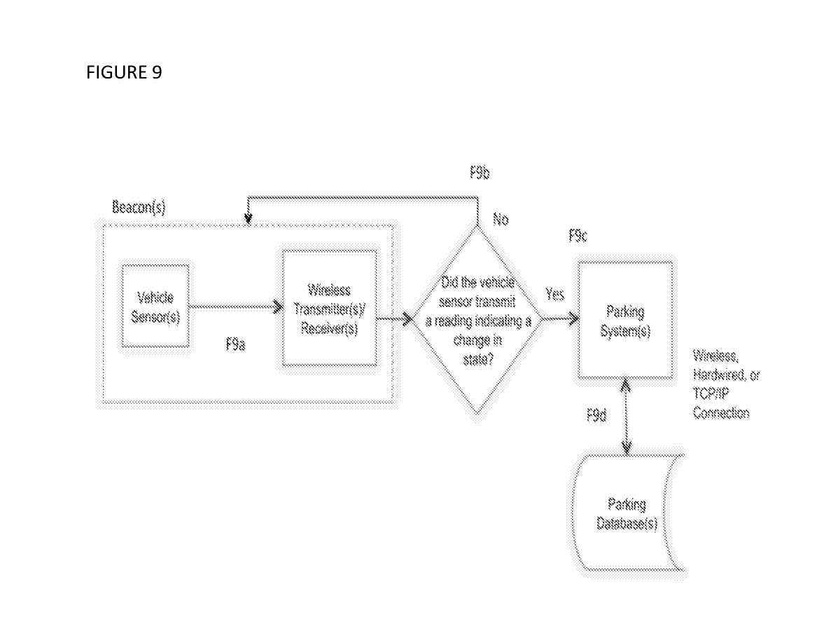

FIG. 9 illustrates how the beacon(s) and vehicle sensor(s) can be used in at least one embodiment for determining parking space availability.

Block F9a illustrates that one or more vehicle sensor(s) can be installed in a given parking space. The vehicle sensor(s) transmit current states to the wireless receiver(s)/transmitter(s) also seen in Block F9a. The transmissions from the vehicle sensor(s) to the wireless receiver(s)/transmitter(s) can be real-time without interruption or can be in system configurable intervals (for example once every 3 seconds, etc.). The wireless receiver(s)/transmitter(s) transmit the vehicle sensor(s) data to the Parking System(s). At decision block F9b if the Parking system(s) determines that the current state of the vehicle sensor(s) for a given parking space remains the same for its configured interval, the system continues to monitor the sensor(s) transmissions. The parking system is represented as block F9c. If the Parking system(s) determines in decision block F9b that the current state of the vehicle sensor(s) for a given parking space changes, optionally for a defined duration or greater then a change threshold, the system notates the change in parking system database at F9d.

The following non-limiting components can be preferably used for operation of at least some of the disclosed embodiments:
1. One or more beacons, communication devices, sensors and/or indicators;
2. A Parking System for receiving data from the one or more beacons, sensors, etc. and sending data to the beacons, communication devices, sensors and/or indicators;
3. Parking Database in electronic communication with the Parking System.

The various components can be in electrical, wired and/or wireless communication with each other.

The system and method disclosed above allows a parking facility to reserve and monitor parking spaces, collect payment, contact drivers, and/or guide users to available parking spaces and can provide significant administrative and safety benefits to parking areas and the general public alike, including, but not limited to, the following public benefits for at least some embodiments:
1. Automation of parking payment systems by eliminating the need for persons to collect payment or monitor/enforce parking rules and/or regulations.
2. Reduction in cost of parking enforcement by eliminating the need for persons to monitor/enforce parking rules, and by automatically deducting payment of fees, charges, fines, etc.
3. Reduction in time spent by drivers in locating parking spots by providing a user with specific parking spot information, which can also include driving directions to reach that spot.
4. Reduction in cost of collecting of payment and/or fines by eliminating delays and labor costs in collection of payment, and by automatically collecting payment from users.
5. Increase in the ability of parking facilities to provide customizable parking options such as variable rates based on time, events and/or location.
6. Reduction in time spent by drivers in entering and/or exiting from parking facilities, by eliminating the need for lines at payment kiosks or gates, because payment is automatically collected from users.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

All components of the described system and their locations, electronic communication methods between the system components, electronic storage mechanisms, etc. discussed above or shown in the drawings, if any, are merely by way of example and are not considered limiting and other component(s) and their locations, electronic communication methods, electronic storage mechanisms, etc. can be chosen and used and all are considered within the scope of the disclosure.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim when and if the claim element, claim step or claim term is interpreted or construed. Similarly, with respect to any “means for” elements in the claims, the inventor considers such language to require only the minimal number of features, components, steps, or parts from the specification to achieve the function of the “means for” language and not all of the features, components, steps or parts describe in the specification that are related to the function of the “means for” language.

The benefits, advantages, solutions to problems, and any element(s) that may cause any benefit, advantage, or solution to occur or become more pronounced are not to be construed or considered as a critical, required, or essential features or elements of any or all the claims.

While the disclosed embodiments have been described and disclosed in certain terms and has disclosed certain embodiments or modifications, persons skilled in the art who have acquainted themselves with the invention, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A system for monitoring one or more parking spots and automatically deducting parking charge from a financial account associated with a registered vehicle, said system comprising:
one or more sensors associated with a parking spot to monitor for vehicles parking in the parking spot;
at least one transmitter/receiver in communication with the one or more sensors;
an electronic parking computer system in communication with the at least one or more sensors;
a database in communication with the electronic parking computer system, the database containing information concerning registered vehicles and unique identifiers assigned to each registered vehicle;
wherein when a vehicle parks in the parking spot the parking of the vehicle is detected by the one or more sensors and forwarded to the electronic parking computer system through the at least one transmitter/receiver and the vehicle transmits an identification signal which is received by the at least one transmitter/receiver and forwarded to the electronic parking computer system by the at least one transmitter/receiver wherein the electronic parking computer system is configures to search the database for a matching identification signal which indicates that the vehicle is a registered user.

2. The system of claim 1 wherein the at least one transmitter/receiver is at least one wireless transmitter/receiver.

3. The system of claim 2 wherein the at least one wireless transmitter/receiver is at least one beacon located at or near the parking spot.

4. The system of claim 1 further comprising an indicator light associated with the parking spot.

5. The system of claim 4 wherein the electronic parking computer system is configured to activate or turn on the indicator light when no vehicle is detected to be parked in the parking spot by the electronic parking computer system from information received from the one or more sensors, wherein the activation or turning on of the indicator lights represents that the parking spot is available.

6. The system of claim 4 wherein the electronic parking computer system is configured to received information when a previously registered vehicle has entered a location associated with the one or more parking spots.

7. The system of claim 6 wherein the electronic parking computer system is configured to determine which spots from the one or more parking spots are currently available and is configured to forward or transmit electronic message to an electronic device of a user associated with a registered vehicle informing the user the spots from the one or more parking spots that are currently available.

8. The system of claim 1 further comprising a software application running on an electronic device for a user associated with a registered vehicle.

9. The system of claim 1 wherein the database containing financial information for each registered vehicle, wherein the electronic parking computer system is configured to automatically deduct any parking charges for a registered vehicle from a user's financial account identified in the financial information stored in the database.

10. A method for automatically identifying one or more parking spots in a parking location by an electronic parking computer system for a registered vehicle, said method comprising the steps of:
a. recognizing by an electronic parking computer system when a registered vehicle has entered or is near a parking location;
b. determining by the electronic parking computer system which parking spots in the parking location are currently available for parking; and
c. electronic forwarding information to an electronic device of a user associated with the registered vehicle identifying the available parking spots.

11. The method for automatically identifying one or more parking spots of claim 10 further comprising the step of electronically receiving a parking spot selection from the user where the information forwarded to the user identified more than one available parking spot.

12. The method for automatically identifying one or more parking spots of claim 10 further comprising the step of automatically deducting a parking charge from a previously registered financial account for the user by the electronic parking computer system.

13. The method for automatically identifying one or more parking spots of claim 10 wherein the information forwarded to a user in step c. also identifies current parking charges or rates for each of the parking spots identified.

14. A method for automatically informing an electronic parking computer system when a vehicle is parked in a monitored parking spot, said method comprising the steps of:
a. providing at least one sensor and at least one beacon at or near a monitored parking spot;
b. electronically transmitting information to the at least one beacon from the at least one sensor when a vehicle parks in the monitored parking spot; and
c. electronically forwarding information to an electronic parking computer system by the at least one beacon representing that a vehicle is parked in the monitored parking spot.

15. The method for automatically informing of claim 14 further comprising the step of verifying that the vehicle parked in the monitored parking spot is an authorized vehicle.

16. The method for automatically informing of claim 15 wherein the step of verifying comprises the steps of:
receiving an identification signal by the beacon transmitted from an electronic system of the vehicle or an electronic device of a user associated with the vehicle;
electronically forwarding the identification signal to the electronic parking computer system by the beacon; and
reviewing a parking database by the electronic parking computer system to verify that the vehicle is listed in the parking database as an authorized vehicle.

17. The method for automatically informing an electronic parking computer system of claim 14 further comprising the step of electronically transmitting information to the electronic parking computer system by the at least one beacon when the vehicle parked in the monitored parking spot has move and is no longer parking in the parking spot.

18. The method for automatically informing an electronic parking computer system of claim 17 determining the length of time that vehicle was parked in the monitored parking spot and calculating a parking charge by the electronic parking computer system.

19. The method for automatically informing an electronic parking computer system of claim 18 further comprising the step of automatically deducting the parking charge from a financial account associated with the vehicle by the electronic parking computer system.
